(19) United States
(12) Patent Application Publication
(10) Pub. No.: US 2007/0071905 A1
(43) Pub. Date: Mar. 29, 2007

(54) Water jet surface treatment of aluminized surfaces for air plasma ceramic coating

(75) Inventors: Jon Conrad Schaeffer, Greenville, SC (US); David V. Bucci, Simpsonville, SC (US)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 11/237,957

(22) Filed: Sep. 29, 2005

(51) Int. Cl. B05D 3/04; B05D 7/00; B05D 1/08

(52) U.S. Cl. 427/446; 427/348; 427/402

(57) ABSTRACT

A method of coating a substrate comprising (a) applying a first coating to the substrate; (b) roughening an outer surface of the first coating using a high pressure water jet; and (c) applying a second coating over the first coating.

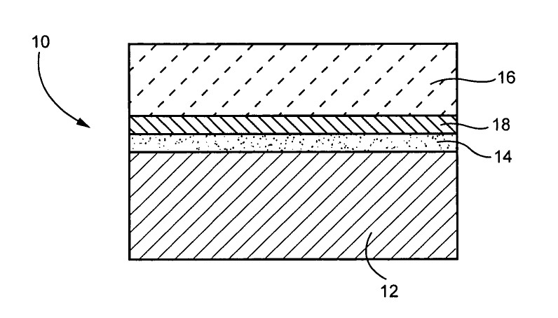

### BACKGROUND OF THE INVENTION

This invention relates generally to rotary machine technology and, more specifically, to thermal barrier coatings for gas turbine or diesel engines.

Coatings are often applied to surfaces of metal articles for use in high-temperature environments to enhance resistance to wear, erosion, corrosion and/or oxidation, or to lower surface temperatures. Oxidation-corrosion protection for a metal is based on the ability to diffuse protective oxide forming elements, such as aluminum and chromium, to the surface of the metal. Protective high temperature oxidation coatings, also known as thermal barrier coatings (TBCs), can be applied by thermal spray and diffusion techniques with advantages and disadvantages for each method. TBCs typically include a bond coating at the substrate, and a ytrria, magnesia or ceria partially-stabilized zirconia top coating.

The zirconia-based top coating (or coat) can be applied by various techniques, but is generally applied by air plasma spray (APS) or electron beam physical vapor deposition (EB-PVD). EB-PVD is commercially successful in the application of ceramic coatings such as stabilized zirconia to aluminide surfaces (PtAl, simple aluminide, aluminized MCrAlY). The EB-PVD TBC zirconia columnar microstructure is strain tolerant and is historically superior to air plasma zirconia with respect to TBC spallation life for high thermal cycle applications. APS processes produce microstructures with vertically-oriented cracks that improve strain tolerance and TBC cyclic spallation life, as disclosed previously in U.S. Pat. No. 5,830,586. Attempts to apply air plasma deposited ceramics to aluminide coating surfaces (diffusion coating on substrate or over aluminide on MCrAlY), however, have not been completely successful, due to insufficient adhesion of the top coat to the smooth surface of the bond coat.

High pressure water jet (HPWJ) techniques have been used to selectively strip coatings in multi-layer coating systems. These techniques have also been used to prepare and/or clean metal surfaces for coating, using a fan jet type nozzle. HPWJ techniques have also been used to remove coatings from a substrate, or to roughen a metal substrate in preparation for coating.

There remains a need for a coating methodology by which ceramic top coatings can be successfully air plasma applied over existing coatings, for example, aluminide bond coat surfaces, in TBC applications.

### BRIEF DESCRIPTION OF THE INVENTION

This invention utilizes HPWJ techniques to roughen a diffusion aluminide surface or bond coat to promote adhesion of a subsequently applied zirconia-based TBC top coating by an APS process. The invention is applicable to any multiple layer coating system, and specifically to TBCs for gas turbine or diesel engines. The “aluminide layer,” i.e., the bond coat layer, refers to an aluminum rich surface layer created by diffusing aluminum from the surface source at temperature by using vapor, packed powder or slurry materials. The aluminide layer can thus be formed by diffusing aluminum into a metal substrate or diffusing aluminum into a metallic coating on a substrate.

Surface roughening of the bond coat by high pressure water jet allows the air plasma ceramic top coat to be applied to the diffusion coated surface (or bond coat) due to a micro-roughening network created by the HPWJ in the surface of the bond coat.

Accordingly, in one embodiment, the invention relates to a method of coating a substrate comprising: (a) providing a first coating on the substrate; (b) roughening an outer surface of the first coating using a high pressure water jet; and (c) applying a second coating over the first coating

In another embodiment, the invention relates to a method of applying a thermal barrier coating to a turbine component comprising: (a) applying a bond coat to an exposed metal surface of the component; (b) roughening an outer surface of the bond coat using a high pressure water jet; and (c) air plasma spraying one or more layers of a ceramic material over the bond coat.

In a further embodiment, the invention relates to a method of roughening a surface of a component comprising:

(a) applying a high pressure, grit-containing water jet at a pressure sufficient to achieve a surface roughness of between 50-750 micro inches on the surface of the component; and (b) applying a top coating on the substrate.

The invention will now be described in detail in connection with the drawing identified below.

### BRIEF DESCRIPTION OF THE DRAWING

The single drawing in the application is a cross-section through a component having a ceramic top coat layer applied over an aluminide bond coat layer in accordance with an exemplary embodiment of the invention.

### DETAILED DESCRIPTION OF THE INVENTION

The drawing FIGURE discloses a component 10 that may be a high temperature component of a gas turbine or diesel engine or any other metal article to which ceramic coatings are applied. The component 10 comprises an underlying metal substrate 12 provided with an aluminide layer 14, or bond coat, applied over the metal substrate 12. More specifically, in a preferred embodiment, the substrate is a metal alloy such as a Ni-based, Ti-based or Co-based alloy. However, substrate 12 could also be comprised of other metal alloys, metal matrix composites and other materials, so long as the substrate is capable of conducting heat sufficient to promote conditions favorable to the formation of a coherent, continuous columnar grain microstructure. Bond coat 14 may comprise of any material which promotes bonding of a top coat or TBC 16 to the substrate 12, and may include, for example, a simple aluminide, PtAl or any aluminum-rich surface layer created by diffusing aluminum into the substrate 12 or into a metallic coating on the substrate.

TBC 16 may comprise plasma-sprayed ceramic materials. In a preferred embodiment, the ceramic material is a metal oxide, such as yttria stabilized zirconia having a composition of 6-8 weight percent yttria with a balance of zirconia that is built up by APS (typically a plurality of layers). However, other TBC materials are possible including metallic carbides, nitrides and other ceramic materials.

In accordance with an exemplary embodiment of the invention, before the TBC top coat 16 is applied over the bond coat 14, the surface of the latter is roughened by a HPWJ treatment. Specifically, a conventional HPWJ apparatus may be employed, running at pressures of 50,000 psi±25,000 psi at a distance of 0.5-3.0 inches from the work to form a roughened layer or surface 18.

Different metals and ceramics react differently to the HPWJ treatment. It will be understood, therefore, that the amount and size of the grit in the water, as well as the application pressure may be varied to obtain the desired degree of roughening in the bond coat, but without removing or otherwise damaging the latter. For TBCs in a typical gas turbine application, the HPWJ should be adjusted to produce a surface roughness value of 50-750 micro inches.

The roughening treatment may also be customized through manipulation of the tooling and/or design of the HPWJ nozzle(s) to produce, for example, a grooved or other pattern on the surface of the bond coat.

The resulting micro-roughening network over the treated surface allows the air plasma ceramic to be applied to the diffusion-contact surface with good adhesion of the TBC top coat.

What is claimed is:

1. A method of coating a substrate comprising:
(a) providing a first coating on the substrate;
(b) roughening an outer surface of said first coating using a high pressure water jet; and
(c) applying a second coating over said first coating.

2. The method of claim 1 wherein said first coating comprises an aluminum-rich surface layer.

3. The method of claim 2 wherein said second coating comprises a yttria-stabilized zirconia coating.

4. The method of claim 1 wherein said second coating comprises a yttria-stabilized zirconia coating.

5. The method of claim 1 wherein said first coating comprises a bond coat to promote adhesion of said second coating to the substrate.

6. The method of claim 1 wherein said first coating comprises an aluminum-rich surface layer.

7. The method of claim 5 wherein said second coating comprises a yttria-stabilized zirconia coating.

8. The method of claim 1 wherein, in step (b) said high pressure water jet is applied at a pressure of 50,000 psi±25,000 psi at a distance of from 0.5-3.0 inches from said substrate.

9. The method of claim 1 wherein said second coating is applied by an air plasma spray process.

10. The method of claim 1 wherein during step (b), said first coating is roughened to a surface roughness of between 50-750 microinches.

11. A method of applying a thermal barrier coating to a turbine component comprising:
(a) applying a bond coat to an exposed metal surface of the component;
(b) roughening an outer surface of said bond coat using a high pressure water jet; and
(c) air plasma spraying one or more layers of a ceramic material over said bond coat.

12. The method of claim 11 wherein said bond coat comprises an aluminide.

13. The method of claim 11 wherein said bond coat comprises an aluminum-rich surface layer.

14. The method of claim 10 wherein said ceramic material comprises a yttria stabilized zirconia.

15. The method of claim 11 wherein said ceramic material comprises a zirconia-based ceramic material.

16. The method of claim 11 wherein the high pressure water jet is applied at 50,000 psi±25,000 psi.

17. The method of claim 16 wherein the high pressure water jet is located between 0.5 and 3.0 inches from the component.

18. A method of roughening a surface of a component comprising:
(a) applying a high pressure, grit-containing water jet at a pressure sufficient to achieve a surface roughness of between 50-750 micro inches on said surface of said component; and
(b) applying a top coating on said substrate.

19. The method of claim 18 wherein said substrate has an aluminide surface layer.

20. The method of claim 18 wherein said top coat comprises a ceramic material.
